(19) United States
(12) Patent Application Publication
(10) Pub. No.: US 2026/0371035 A1
(43) Pub. Date: Nov. 19, 2026

(54) TECHNIQUES FOR PROVIDING AND USING LOCATION PROFILES AND ASSOCIATED INFORMATION

(71) Applicant: Apple Inc., Cupertino, CA (US)

(72) Inventors: Richard B. Warren, Emerald Hills, CA (US); Adam J. Leonard, San Francisco, CA (US); Emmanouil Alimpertis, San Fransisco, CA (US); Long Gao, Cupertino, CA (US); Ricky Wing Kei Tai, Milpitas, CA (US); Todd R. Grooms, Nashville, TN (US)

(73) Assignee: Apple Inc., Cupertino, CA (US)

(21) Appl. No.: 19/682,344

(22) Filed: May 19, 2026

Related U.S. Application Data
(60) Provisional application No. 63/808,459, filed on May 19, 2025.

(51) Int. Cl. H04W 4/024

(52) U.S. Cl. CPC H04W 4/024

(57) ABSTRACT

The techniques described herein relate to location services. The techniques can include obtaining, by a location service on a user device, a map representative of a geographic area including a position of the user device. The map can include one or more locations in the geographic area. The techniques can include obtaining sensor data received by the user device at the position of the user device. The techniques can include determining a location profile based at least in part on the one or more locations of the map and the sensor data. The techniques can include providing the location profile to a client application on the user device.

### CROSS-REFERENCES TO RELATED APPLICATIONS

This application claims the benefit of U.S. Provisional Application No. 63/808,459, filed on May 19, 2025, which is hereby incorporated by reference in its entirety.

### BACKGROUND

With the proliferation of mobile devices, location services are used by a variety of services and applications. Some uses for location services include identifying specific locations (for example, a specific building or area) and presenting information related to these specific locations. Other services and applications may subscribe to the identification of specific locations and information related to the specific locations.

### BRIEF SUMMARY

In accordance with one embodiment, a method may include accessing, by an application executed on a user device, location data corresponding to a location of the user device. For at least a subset of the location data, the method may include identifying, by the application, tuples including respective time components for each portion of the subset of the location data. The method may further include identifying, by the application, a first location, a second location, and at least one intermediate location from the subset of the location data based at least in part on the identified tuples. The method may also include determining, by the application, whether the first location, the second location, and the at least one intermediate location are sequentially correlated above a threshold frequency. In accordance with a determination that the first location, the second location, and the at least one intermediate location are correlated above the threshold frequency, the method may include generating, by the application, a first route including the first location, the second location, and the at least one intermediate location, and storing, by the application, the first route on the user device.

In some embodiments, the at least one intermediate location may be a first intermediate location of multiple intermediate locations between the first location and the second location. In these or other embodiments, the first route may be further generated to include at least a subset of the multiple intermediate locations between the first location and the second location. In some embodiments, the method may further include receiving, by the application, data indicating a request for a second route including a third location, generating, by the application, the second route including the third location, where the second route may be generated to correspond to at least a portion of the first route, and generating, by the application, a notification of the second route for display by the user device.

In some embodiments, a request for a second route may be generated in response to a navigation request from the user device. The method may further include determining, by the application, that a third location may be within a predetermined radius from at least one of the first location, the second location, or the at least one intermediate location, and determining, by the application, that at least a portion of the first route may be a potential route to the third location. In some embodiments, the application may communicate with a routing service component of a remote computing system.

In some embodiments, a request for a second route may be generated in response to an alert received by the user device. The method may further include determining, by the application, that the alert may indicate an unavailable portion of the first route, where the unavailable portion may be below a threshold percentage of the first route. The method may also include determining, by the application, the second route to bypass the unavailable portion of the first route and to maximize a portion of the second route to correspond to the first route, and generating, by the application, an alert notification indicating at least one of the unavailable portion or the second route.

In some embodiments, a request for a second route may be generated in response to determining that the user device has deviated from the first route. The method may further include determining, by the application, the second route from a third location to a position corresponding to the first route. In some embodiments, the method may further include determining, by the application, a predicted future location based at least in part on the location data, determining, by the application, that the predicted future location may be accessible via at least a portion of the first route, and generating, by the application, the second route including the portion of the first route and the predicted future location. In some embodiments, the application may transmit the location data to a computing system according to a timing interval.

In accordance with another embodiment, a system may include one or more processors and a computer readable memory including instructions that, when executed by the one or more processors, may cause the system to perform operations. The operations may include accessing, by an application executed on a user device, location data corresponding to a location of the user device. For at least a subset of the data, the operations may include identifying, by the application, tuples including respective time components for each portion of the subset of the location data, and identifying, by the application, a first location, a second location, and at least one intermediate location from the subset of the location data based at least in part on the identified tuples. The operations may further include determining, by the application, whether the first location, the second location, and the at least one intermediate location are sequentially correlated above a threshold frequency. In accordance with a determination that the first location, the second location, and the at least one intermediate location are correlated above the threshold frequency, the operations may include generating, by the application, a first route including the first location, the second location, and the at least one intermediate location, and storing, by the application, the first route on the user device.

In some embodiments, a second route may include two or more transportation modes. In some embodiments, the first location and the second location may be identified as familiar locations based at least in part on a time component of the location data. In some embodiments, the application may determine a second route based at least in part on a time of day. In some embodiments, the operations may further include executing a privacy service configured to remove sensitive information from the location data prior to the location data being transmitted by the user device.

In accordance with another embodiment, a non-transitory computer-readable medium may store instructions that, when executed by one or more processors, may cause the one or more processors to perform operations. The operations may include accessing, by an application executed on a user device, location data corresponding to a location of the user device. For at least a subset of the location data, the operations may include identifying, by the application, tuples including respective time components for each portion of the subset of the location data, and identifying, by the application, a first location, a second location, and at least one intermediate location from the subset of the location data based at least in part on the identified tuples. The operations may further include determining, by the application, whether the first location, the second location, and the at least one intermediate location are sequentially correlated above a threshold frequency. In accordance with a determination that the first location, the second location, and the at least one intermediate location are correlated above the threshold frequency, the operations may include generating, by the application, a first route including the first location, the second location, and the at least one intermediate location, and storing, by the application, the first route on the user device.

In some embodiments, the first route may be determined based on location data corresponding to a number of days. In some embodiments, a routing service may reconstruct the first route based on the location data. In some embodiments, the application may transmit the location data to a computing system at a regular interval. In some embodiments, the location data may be based at least in part on cell tower triangulation (CTT) data, global positioning satellite (GPS) data, Wi-Fi localization, or some combination of these.

### BRIEF DESCRIPTION OF THE DRAWINGS

FIG. 1 illustrates a diagram associated with the techniques described herein, according to an embodiment of the present disclosure.

FIG. 2 illustrates a diagram associated with the techniques described herein, according to an embodiment of the present disclosure.

FIG. 3 illustrates a diagram associated with the techniques described herein, according to an embodiment of the present disclosure.

FIG. 4 illustrates a diagram associated with the techniques described herein, according to an embodiment of the present disclosure.

FIG. 5 illustrates a flow diagram associated with the techniques described herein, according to an embodiment of the present disclosure.

FIG. 6 illustrates an example architecture or environment configured to implement the techniques described herein, according to an embodiment of the present disclosure.

FIGS. 7A-7F. show example application programming interfaces (APIs), according to an embodiment of the present disclosure.

### DETAILED DESCRIPTION

Certain embodiments of the present disclosure relate to devices, computer-readable media, and methods for implementing various techniques for providing and using detailed location profiles and associated information with client applications on a user device. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

User devices are able to estimate geographic position data, for example, based on information received from global navigation satellite systems (GNSS). In some examples, the geographic position data can be referred to as a geodetic location or geodetic position. A geodetic location or geodetic position can be a pair of longitude and latitude coordinates. However, due to the limitations of GNSS, the geographic position data can have a level of error or lack of precision. This is especially true when a user is in a building or when a direct connection to the GNSS is attenuated.

Furthermore, geographic position data for a user device does not indicate information regarding locations near the user device. Rather, the geographic position data for a user device can be used to determine nearby locations through location services. Locations can be specific areas such as a particular park or parking lot, or a specific building, store, or business. Locations can also be referred to as points-of-interest (POIs). In some examples, the user device can transmit its geographic position data to location services (for example, hosted on one or more servers). The location services can then identify locations and a corresponding location profile to transmit back to the user device. The location profile can include location information details and location-related metadata such as the name, location type, address, a boundary for the location, and other information regarding the location. Location profiles can be useful to client applications for providing additional services on the user device.

As previously noted, the geographic position data may not be precise enough to determine the exact location where the user device is located. For example, a user device may be in a mall. The geographic position data may not be sufficiently accurate enough to determine whether the user device is located within a boundary of adjacent stores. However, functionality of a client application may rely on a more accurate and/or precise determination of whether the user device is within the boundaries of a location. The user device can use a map of the geographic area around the current position of the user device and sensor data at the current position of the user device in order to determine the location corresponding to the user device's position. In some examples, the sensor data can correspond to wireless signals. These wireless signals can include cellular signals, Wi-Fi signals, Bluetooth signals, ultra-wideband (UWB) signals, or any other wireless signal. The wireless signals can also be a combination of multiple different wireless signal types (for example, two or more cellular signals, Wi-Fi signals, Bluetooth signals, or any other wireless signal). In some examples, the sensor data can include device motion data from an inertial measurement unit (IMU). For example, device motion data can indicate the user holding or storing the user device is walking back and forth. In another example, the device motion data can indicate that the user holding or storing the user device is sitting. In another example, the device motion data can be used with geolocation trajectories. The sensor data can correlate to where the user device is located within the map of the geographic area around the current position of the user device.

Furthermore, enabling the determination of location profiles and related location information on the user device can result in significant resource savings. Repeated requests to centralized servers are costly, with respect to device power, cellular bandwidth, server capacity, user privacy, and other resources. Continually sending geographic position data to a location services server for use in determining location profiles and associated information for nearby locations involves significant resources. For example, a connection to the server from the user device may be required in order to transmit the geographic position data and receive the location profile and associated information. Certain types of network connections can be limited for a variety of reasons. For example, a data connection through a cellular network can be a costly resource to frequently use to request location profiles and associated information from location services servers. Similarly, the bandwidth for communication between a user device and a server is a limited resource that is shared across many services for data requests and transmissions. Transmissions also consume power such that consumption for repeated transmitting and receiving of location profiles and associated information can incur high resource costs on a user device. Furthermore, the processing of location services requests from user devices can use significant server processing resources. As the ever-growing number of devices and device-level services request location profiles and associated information, more server processing resources are needed. Server processing resources may need to be sufficient during peak usage but may be too costly for lulls in usage. In this way, proper scaling of server processing resources can be difficult.

The techniques described herein enable on-device determination of location profiles and associated information to be maximized in order to limit the resource consumption of transmitting and requesting location profiles and associated information from a server. On-device processing resources may be a more efficient way to scale the determination of location profiles and associated information than requiring scaling server processing resources. Oftentimes, the processing resources on-device are not frequently at peak usage, and additional processing resources on-device are available.

The techniques described herein also enable additional features for client applications subscribing to and/or using location profiles and associated information. Client applications can use location profiles and associated information to surface reminders, notifications, or make suggestions through a user interface of a user device. By enabling the determination of location profiles on the user device without the need for on-demand location information from a server, client applications can more readily access location profiles. Additionally, determining location information on the user device can improve data security and privacy for data related to the user of the user device. For example, determining location profiles through the use of a location services server involves the transmission of position data for the user device. Position data for user devices is becoming increasingly important for data security and privacy.

An example client application may be a maps application. When the maps application is an active application (for example, an application that is currently being interacted with through a user interface of the user device), the maps application may be able to present location profiles and associated information for a current location of the user. Similarly, the maps application may be able to present location profiles for previous locations of the user device during a past time period. This can enable a user to access location profiles for a variety of locations very quickly without requiring the user device to request location information from a server.

In another example, a client application may relate to a workout application. When a user device is at or near a location where there has been frequent past use of workout-related information or applications, similar workout-related information or applications can be surfaced to a user as a suggestion or notification. For example, an application for yoga may be routinely activated or used at a particular park. When the user device returns to that particular park, the user device can surface a reminder or notification regarding yoga or surface the yoga application.

In another example, a client application hosted on a companion device for the user device can use location services. A companion device can be a device that is connected via a wireless connection (or other connection) to the user device (e.g., a smart watch or other user peripheral that works with the user device). The user device can periodically transmit location profiles and associated information to the companion device to enable client application functionality on the companion device. For example, the user interface of the companion device may include location-based widgets and notifications. Companion devices often have limited resources such as power, bandwidth and connection, and processing resources. In some examples, companion devices have significantly limited resources in relation to user devices. In this way, the location profiles may not be determined by the companion device but rather received from the user device in order to conserve companion device resources.

In a particular example, a user and corresponding user device, such as a phone, can arrive at a restaurant. The user device can send estimate position data for the user device (e.g., from GNSS signals). The user device can determine that the user device has a cached map on the device that includes the current position of the user device. The user device can also detect a set of Wi-Fi signals in the area around the user device. The location generator of the user device can generate a location unique identifier based on the set of Wi-Fi signals and the cached map that corresponds to the restaurant. The user device can identify a location profile for the restaurant that is associated with the location unique identifier. A client application for the restaurant chain can cause a notification or suggestion to appear on the user interface of the user device showing deals and new dishes that are being offered. While the user is waiting to order food, the user can look at their maps application and see a set of icons for location profiles related to previous locations that the user has visited in the last week. The user can select one of these icons and a location profile can be shown to the user. The user can also have a companion device, such as a smart watch, that is associated with the user device. The location profile information and visit information for when the user arrives at the restaurant can be transmitted to the companion device. The companion device can have a widget related to calorie counting or general fitness. The companion device can generate a notification or reminder regarding the calorie counting goals of the user. The location profile information determined on the user device can enable this kind of functionality when used by client applications.

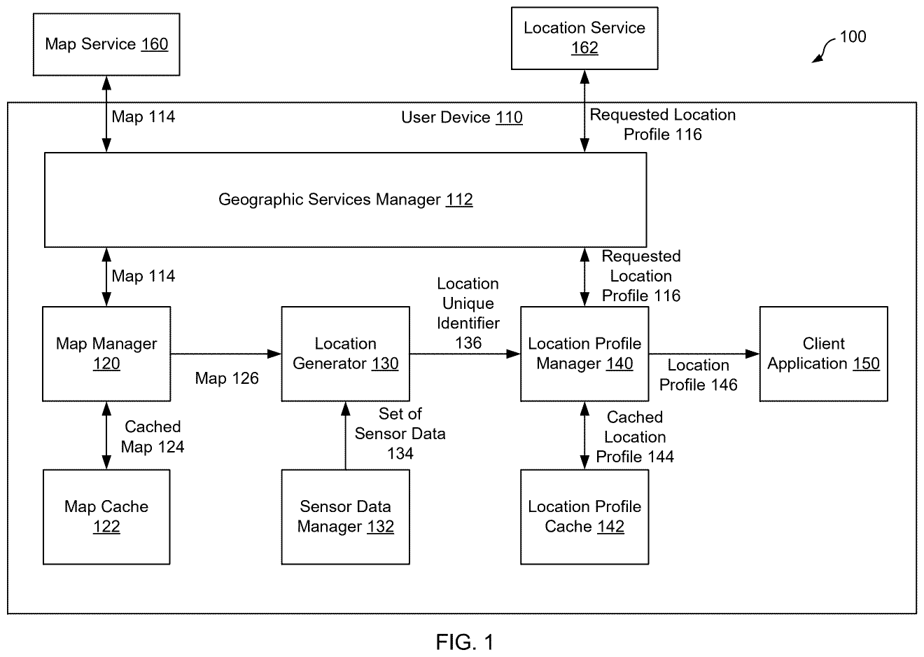

FIG. 1 illustrates a diagram 100 related to the techniques described herein. A user device 110 can provide a location profile including location information to a client application 150 on the user device 110. The map manager 120 can determine a map 126 and provide the map 126 to the location generator 130. The location generator 130 can generate and/or determine a location unique identifier 136 and provide the location unique identifier 136 to the location profile manager 140. The location manager can generate a location profile 146 and provide the location profile 146 to the client application 150. The client application 150 can use the location profile 146 to provide functionality on the user device 110 as described herein.

The map manager 120 can determine a map 126 to provide to the location generator 130. The map 126 can be representative of a geographic area including a position of the user device 110. The position of the user device 110 can be a set of coordinates for the user device 110. For example, the position of the user device 110 can be determined via a global navigation satellite system (GNSS) such as global positioning system (GPS). The position of the user device 110 can be coordinates such as a longitude and a latitude. The user device 110 can receive the position of the user device 110. The map manager 120 can then identify a map 126 that includes the position of the user device 110. In some examples, the map 126 can be referred to as a tile of a global map. The map 126 covers a limited geographic area such that a global map includes multiple maps like the map 126. In some examples, the map 126 can be restricted to a part of a city or a particular area of coordinates. For example, the map 126 can be restricted to a five-mile by five-mile area of the surface of the globe.

In some examples, the map manager 120 can request a map 114 that contains the position of the user device 110. The map manager 120 can send a request for the map 114 to a geographic services manager 112 of the user device 110. The request for the map 114 can include a position of the user device 110. The geographic services manager 112 can coordinate various types of geographic, map, and location data. The geographic services manager 112 can send a request for the map 114 to a map service 160. The request for the map 114 can include a position of the user device 110. The map service 160 can be a service that identifies maps that include one or more positions. In some examples, the map service 160 is a service provided by one or more servers to service map requests. The map service 160 can identify a map 114 that contains the position of the user device 110. The map service 160 can transmit the map 114 to the user device 110. The geographic services manager 112 can receive the map 114 and forward the map 114 to the map manager 120.

In some examples, the map manager 120 can determine if there is a cached map 124 in the map cache 122 of the user device 110 that contains the position of the user device 110. A cached map 124 in the map cache 122 is a map 114 that has been received by the user device 110 at an earlier time from the map service 160. In some examples, the map manager 120 can first determine if there is a cached map 124 in the map cache 122 that contains the position of the user device 110 prior to requesting a map 114 from the map service 160. In some examples, a cached map 124 in the map cache 122 can be associated with a timestamp. If the timestamp is beyond a threshold time in the past, the map manager 120 may determine to request the map again to refresh information regarding the map. Once the map 126 that contains the position of the user device 110 has been determined by the map manager 120, the map manager can send the map 126 to the location generator 130.

The location generator 130 can receive the map 126 from the map manager 120. The location generator 130 can also receive sensor data 134 from a sensor data manager 132. In some examples, the location generator 130 can request sensor data from the sensor data manager 132 after receiving the map 126 from the map manager 120. In some examples, sensor data can include a set of signal strengths. The sensor data manager 132 can use an antenna of the user device 110 to measure a set of signal strengths. In some examples, the sensor data 134 can be a set of wireless signal strengths. The wireless signal strengths can be related to cellular, Wi-Fi, Bluetooth, or other wireless signals. Each signal strength can also correspond to metadata regarding the signal strength. For example, the metadata can include a type of signal (for example, cellular, Wi-Fi, Bluetooth), a frequency of the signal, a wavelength of the signal, or information provided in the signal. For example, if the signal is a Wi-Fi signal, the Wi-Fi signal may include information like a service set identifier (SSID) for a Wi-Fi network associated with the Wi-Fi signal. The set of signal strengths can also be referred to as a signal fingerprint. A set of wireless signal strengths can be referred to as a wireless signal fingerprint, and a set of Wi-Fi signal strengths can be referred to as a Wi-Fi fingerprint. In some examples, the set of signal strengths can include signal strengths from multiple types of signals. For example, one signal strength of the set of signal strengths can be associated with a cellular signal, while another signal strength can be associated with a Wi-Fi signal. In some examples, the set of signal strengths can be a vector of signal strength information. In some examples, other parts of signals can be used as well. For example, the service set identifier (SSID) of a signal can be used as sensor data. In some examples, transaction data on the user device or related to a profile on the user device that is related to the location can be used. For example, if the location is a store, transaction data related to the store can be used. In some examples, the sensor data 134 can include device motion data from an inertial measurement unit (IMU). For example, device motion data can indicate that the user holding or storing the user device is walking back and forth. In another example, the device motion data can indicate that the user holding or storing the user device is sitting. In another example, the device motion data can be used with geolocation trajectories. Device motion data can be used in conjunction with position data (for example, from GNSS) in order to generate an estimated position for the user device.

The location generator 130 can determine a location unique identifier 136 based on one or more of: the map 126 and the sensor data 134. The location unique identifier 136 is a unique identifier tied to a specific location and its associated location profile. For example, there is a specific location unique identifier 136 for a first store in a first city and a second specific location unique identifier 136 for a second store in a second city, even if the first store and the second store are associated with the same company or brand. The map 126 can provide context information regarding locations on the map 126. In some examples, the map 126 includes polygons indicating boundaries for locations on the map 126. In some examples, the map 126 includes location unique identifiers 136 for the locations on the map 126. The sensor data 134 can be analyzed to determine a location and associated location profile corresponding to the position within the map 126 for where the sensor data 134 were measured. The location unique identifier 136 can be referred to as a map unique identifier. In some examples, the location corresponding to a location unique identifier 136 can be referred to as a place-of-interest (POI).

In some examples, the location generator 130 can determine a location unique identifier 136 based on geometric boundaries contained within a location profile. In some examples, the location generator 130 can determine a location unique identifier 136 based on the relative proximity of the user device to the geolocations (for example, the positions) of nearby places (for example, locations) from the map, and/or to known features of those places, from their respective location profiles, such as doorways. In some examples, the location generator 130 can determine a location unique identifier 136 based on the observed trajectory of the user device, approaching some place(s) and moving farther away from others.

In some examples, the location generator 130 can be a part of an operating system or an application. The location generator 130 can receive the map 126 and/or the sensor data 134 (and related metadata) and determine a location and associated location profile corresponding to the position of where the sensor data 134 were measured. In some examples, the position of where the sensor data 134 was measured is a current position of the user device 110. In some examples, the sensor data 134 can include historical data from the IMU. The sensor data 134 from an IMU can aid in determining an estimated position for the user device.

In some examples, the location generator 130 can be an artificial intelligence model, such as a machine learning model. The machine learning model can be trained to receive the map 126 and/or the sensor data 134 (and related metadata) and determine a location and associated location profile corresponding to the position of where the sensor data 134 were measured. In some examples, the position of where the sensor data 134 was measured is a current position of the user device 110. In some examples, the sensor data 134 can include historical data from the IMU. The sensor data 134 from an IMU can aid in determining an estimated position for the user device.

In some examples, the map 126 includes one or more models to be used by the location generator 130 to determine the location unique identifier 136. The location generator 130 can use one or more models of the map 126 and the sensor data 134 to determine a location unique identifier 136. In some examples, the map 126 can also include locations that are not within the represented geographic area of the map 126 but are near the edges of the map 126. A map 126 can include one or more models that can be used to determine a particular set of locations within the map. In some examples, a map 126 may contain locations that aren't associated with any of the same Wi-Fi observations such as the first and twentieth stories of a tall building. In such cases, there may be multiple models for the map 126 that each cover a set of locations that are confused with one another. In some examples, the one or more models are machine learning models.

The location generator 130 can provide (for example, transmit or send) the location unique identifier 136 to the location profile manager 140. In some examples, the location generator 130 can determine a location unique identifier confidence value associated with a corresponding location unique identifier 136. The location unique identifier confidence value can indicate how likely the location unique identifier 136 is correct or a certainty regarding the outputted location unique identifier 136. A low location unique identifier confidence value indicates that the location generator 130 outputted a location unique identifier 136, but it has a higher likelihood of being incorrect. A high location unique identifier confidence value indicates that the location generator 130 outputted a location unique identifier 136, but it has a higher likelihood of being correct. A location unique identifier confidence value can be higher when there are fewer locations within a map. Similarly, a location unique identifier confidence value can be higher when the position of the user device 110 is within the boundaries of a polygon associated with a location.

The location profile manager 140 can receive the location unique identifier 136 and determine a location profile 146. The location profile 146 can correspond to a particular store, park, building, or other designated area. The location profile 146 can include location information regarding the location profile 146. The location information can include a name of the location profile 146, an address of the location profile 146, hours of operation of the location profile 146, a location type of the location profile 146, and other metadata related to the location profile 146. A location type can indicate a classification or tag related to the location profile 146. A location type can include a brand or company name, a type of good or service, or any other classification regarding the location profile 146.

In some examples, the location profile manager 140 can send a request for a requested location profile 116. The location profile manager 140 can send a request for the requested location profile 116 to a geographic services manager 112 of the user device 110. This request for the requested location profile 116 can include a location unique identifier 136. The geographic services manager 112 can send a request for the requested location profile 116 to a location service 162. This request for the requested location profile 116 can include a location unique identifier 136. The location service 162 can be a service that identifies locations that correspond to location unique identifiers 136. In some examples, the location service 162 is a service provided by one or more servers to service location requests. The location service 162 can identify a requested location profile 116 that corresponds to the location unique identifier 136. The map service 160 can transmit the requested location profile 116 and associated location information and metadata to the user device 110. The geographic services manager 112 can receive the requested location profile 116 and associated location information and metadata and forward the requested location profile 116 and associated location information and metadata to the location profile manager 140. Associated location information and metadata can include a position of the location, such as a longitude and latitude for the location. Associated location information and metadata can include a polygon indicating borders for the location on a map. In some examples, the position of the location can be approximate to a center of the polygon. The associated location information and metadata can include a name of the location, an address of the location, hours of operation of the location, a location type of the location, and other metadata related to the location. A location type can indicate a classification or tag related to the location. A location type can include a brand or company name, a type of good or service, or any other classification regarding the location.

In some examples, the location profile manager 140 can determine if there is a cached location profile 144 in the location profile cache 142 of the user device 110 that corresponds to the location unique identifier 136. A cached location profile 144 in the location profile cache 142 is a requested location profile 116 that has been received by the user device 110 at an earlier time from the location service 162. In some examples, the location profile manager 140 can first determine if there is a cached location profile 144 in the location profile cache 142 that corresponds to the location unique identifier 136 prior to requesting a requested location profile 116 from the location service 162. In some examples, a cached location profile 144 in the location profile cache 142 can be associated with a timestamp. If the timestamp is beyond a threshold time in the past, the location profile manager 140 may determine to request the location again to refresh information regarding the location. Once the location profile 146 that corresponds to the location unique identifier 136 has been determined by the location profile manager 140, the location profile manager 140 can provide the location profile 146 to a client application 150.

The client application 150 can use the location profile 146 for a variety of functionalities and purposes. In some examples, the location profile 146 relates to a current position of the user device 110. In such examples, a client application 150 can use the location profile 146 to surface reminders, notifications, or other information on the user interface of the user device 110.

In one example, the client application 150 can be a maps application. The maps application can surface a location profile and/or associated information for a current location associated with a current position of the user device 110. In some examples, the current location profile and/or associated information can be presented when the user device 110 is instructed (for example, via a user using a user interface of the user device 110) to open the maps application. The current location profile and/or associated information can depend on the type of location. For example, if the current location is a restaurant, the current location profile and/or associated information can include opening and closing times, menus, and featured information regarding the restaurant.

In another example, the client application 150 can be a workout application. When the position of the user device 110 indicates that the user device 110 is near a location associated with workouts, workout related information, features, and notifications can be surfaced on the user device 110. In some examples, the location is personally associated with a user of the user device 110. For example, a location may be a park where the user runs. When the user device 110 is determined to be near the location, the workout application can surface workout related information related to starting a new running workout or information from a previous workout. Meanwhile, when the user device 110 arrives at a second park, no workout related information may be surfaced because the associated user does not typically workout at the second park. In some examples, the location is generally associated with workouts. For example, a location may be a gym where a person can go swimming or lift weights. When the user device 110 is determined to be near such a location, the workout application can surface workout related information related to swimming and/or lifting weights regardless of whether the user has performed such workouts (or initiated such workouts in the workout application) while at this location. In such examples, the workout application can surface information for a location associated with workouts.

In some examples, the map manager 120 (or a system controlling the map manager 120) can request and cache maps for particular positions and/or locations without receiving an active request for the map by an application on the user device 110 or via interaction with a user interface of the user device 110. For example, the map manager 120 can request and cache a map 114 that includes a previous position of the user device 110. In another example, the map manager 120 can receive a request to cache a map that contains a previous location associated with a previous position of the user device 110. In another example, a user device 110 may be predicted to visit the location in the near future. The map manager 120 can receive a request to cache a map that contains this future location.

In some examples, the map manager 120 can request and cache maps that are adjacent to a map including the current position of the user device 110. In this way, the adjacent maps can be pre-fetched for use in determining future locations.

In some examples, the location profile manager 140 (or a system controlling the location profile manager 140) can request and cache locations for particular positions and/or locations without receiving an active request for the location by an application on the user device 110 or via interaction with a user interface of the user device 110. For example, the location profile manager 140 can request and cache a location that includes a previous position of the user device 110. In another example, the location profile manager 140 can receive a request to cache a location for a previous location associated with a previous position of the user device 110. In another example, a user device 110 may be predicted to visit the location in the near future. The location profile manager 140 can receive a request to cache the future location.

In some examples, the pre-caching and pre-fetching of maps and locations by the map manager 120 and the location profile manager 140 can be performed while the user device 110 is connected to a network that has greater resources or while the user device 110 has increased resources. For example, pre-caching and pre-fetching may occur while a user device 110 is charging or refilling the battery of the user device 110. In another example, pre-caching and pre-fetching may occur while a user device 110 is connected to a particular type of network that is associated with using fewer resources. For example, pre-caching and pre-fetching may occur while a user device 110 is connected to a Wi-Fi network. In another example, the user device 110 can pre-cache and pre-fetch maps and/or locations when the user device 110 is charging and connected to a Wi-Fi network.

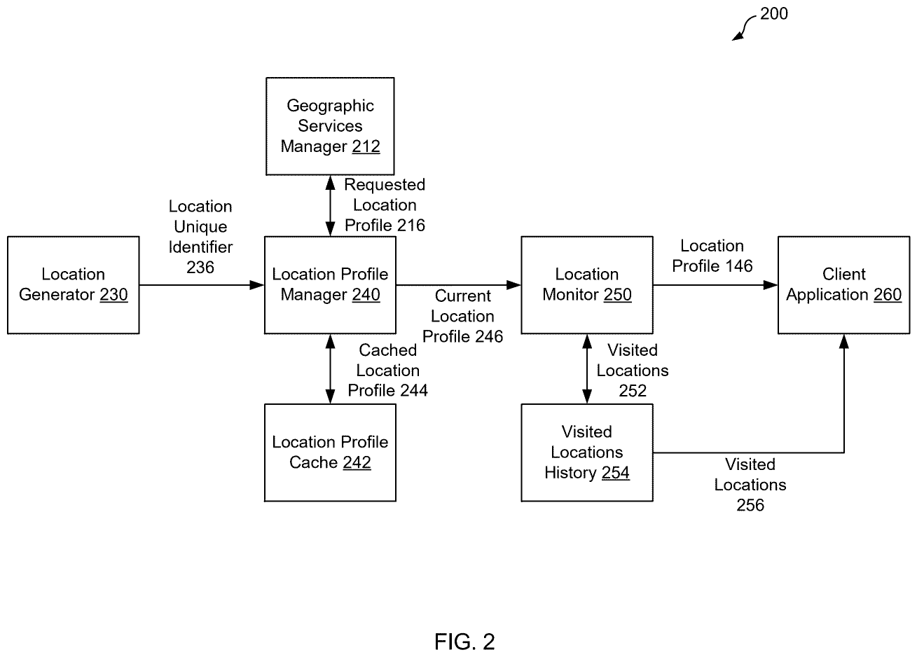

The techniques described in relation to FIG. 1 can be referred to on-demand location determinations. On-demand location determinations can provide location profiles and associated information as needed by one or more client application 150. FIG. 2 can be used to describe background location monitoring.

FIG. 2 illustrates a diagram 200 related to techniques described herein. A user device (for example, the user device 110 of FIG. 1) can have a location generator 230 (for example, the location generator 130 of FIG. 1), a location profile manager 240 (for example, the location profile manager 140 of FIG. 1), a location profile cache 242 (for example, the location profile cache 142 of FIG. 1), and a client application 260 (for example, the client application 150 of FIG. 1). Similarly, the user device can have a geographic services manager 212 (for example, the geographic services manager 112 of FIG. 1). The location generator 230 can determine a location unique identifier 236 (for example, the location unique identifier 136 of FIG. 1) and provide the location unique identifier 236 to the location profile manager 240. In some examples, the location profile manager 240 can determine a current location profile 246 by receiving a cached location profile 244 from the location profile cache 242 that corresponds to the location unique identifier 236. In some examples, the location profile manager 240 can determine a current location profile 246 by receiving a requested location profile 216 through the geographic services manager 212 after providing the location unique identifier 236.

The location profile manager 240 can provide the current location profile 246 to a location monitor 250. The location monitor 250 enables background location determination and related services and functionality. The location monitor 250 can periodically receive (and in some examples, request) the current location profile 246 from the location profile manager 240. The location monitor 250 can include a timestamp for the current location profile 246 and determine that the current location profile 246 now represents a visited location 252 where the user device was previously positioned and/or located. The visited locations 252 can be stored in a visited locations history 254. The visited locations 252 stored in the visited locations history 254 can be location profiles for the visited locations 252. Location profiles and associated information related to the visited locations 252 can also be stored in the visited locations history 254 in addition to the timestamp of the visit.

A client application 260 can request the visited locations 256 from the visited locations history 254 as well as a location currently associated with the position of the user device. The visited locations 256 can be location profiles. The visited locations 256 can enable client applications 260 to provide additional functionality such as reminders, notifications, or surfacing of information on a user interface of the user device. For example, a maps application hosted on the user device can be active and present user interface elements related to visited locations 256. The user interface can indicate one or more visited locations 256 and their associated location information.

In some examples, visited locations 252 can be associated with a visit entry. A visit entry can be an earliest timestamp associated with the visited location prior to leaving the visited location. Likewise, visited locations 252 can be associated with a visit exit. A visit exit can be a latest (or last) timestamp associated with the visited location prior to arriving at another location.

In some examples, a visit to a location can be estimated based on an aggregation of locations identified by the location profile manager 240. For example, the location profile manager 240 may periodically determine the location associated with the current position of the user device. Instead of relying only on the most recently determined location, the location profile manager 240 can aggregate a number of the previously determined locations to increase confidence in the location determination. However, if there is a significant change in position of the user, older location determinations may not increase confidence in the location determination. Similarly, location determinations influence confidence less and less as time passes. For example, a location determination from an hour ago may have less influence on confidence than a location determination from ten minutes ago. Overall, aggregating the location determinations can reduce noise related to the location determinations.

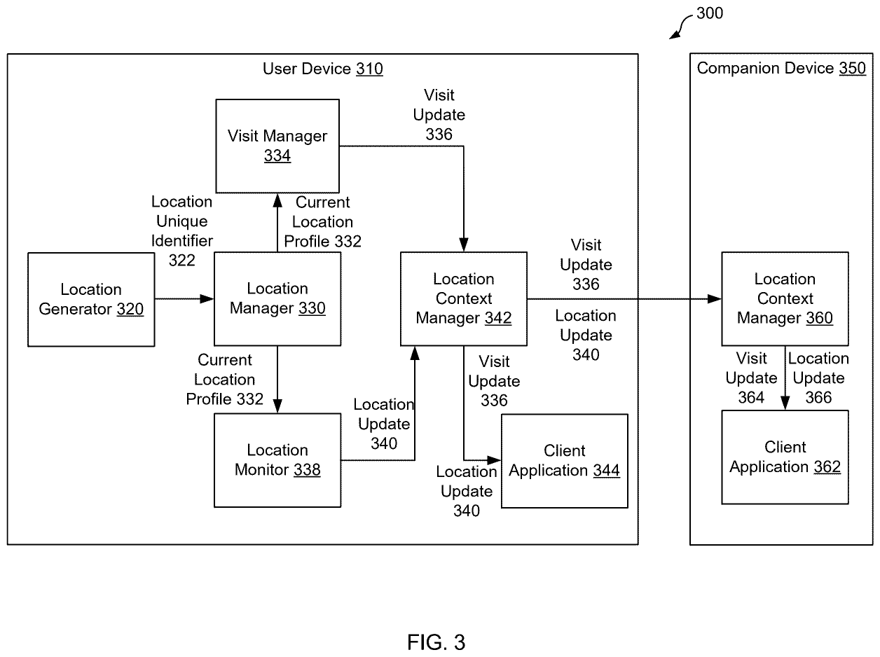

FIG. 3 illustrates a diagram 300 related to techniques described herein. Here, a user device 310 can share location profiles and location information with a companion device 350 to enable functionality on the companion device 350. In some examples, the user device 310 can be a phone while the companion device 350 can be a watch, glasses, or some other small accessory.

A user device 310 (for example, the user device 110 of FIG. 1) can have a location generator 320 (for example, the location generator 130 of FIG. 1), a location manager 330 (for example, the location profile manager 140 of FIG. 1), and a client application 344 (for example, the client application 150 of FIG. 1). The location generator 320 can determine a location unique identifier 322 (for example, the location unique identifier 136 of FIG. 1) and provide the location unique identifier 322 to the location manager 330. In some examples, the location manager 330 can determine a current location profile 332 by receiving a cached location profile from the location profile cache that corresponds to the location unique identifier 322 as described in relation to FIGS. 1-2. In some examples, the location manager 330 can determine a current location profile 332 by receiving a requested location profile through the geographic services manager after providing the location unique identifier 322 as described in relation to FIGS. 1-2.

The location manager 330 can provide the current location profile 332 to both a visit manager 334 and a location monitor 338 (for example, the location monitor 250 of FIG. 2). The visit manager 334 can use current locations from the location manager 330 to determine when there is a visit entry at a location and a visit exit at the location as described herein. Visit entries and visit exits at particular locations are examples of visit updates 336. Visit updates 336 can include a location profile or associated location information.

A location context manager 342 can be an example client application (for example, the client application 150 of FIG. 1) that can receive visit updates 336 from the visit manager 334 and location updates 340 from the location monitor 338. Location updates 340 can represent changes in a current location or updates to visited locations. The location context manager 342 can provide location updates 340 and visit updates 336 to other client applications 344 as well. Location updates 340 can include a location profile or associated location information.

The location context manager 342 of user device 310 can transmit location updates 340 and visit updates 336 to a location context manager 360 of a companion device 350. In some examples, the location context manager 342 sends a subset of the location updates 340 and visit updates 336 received by the location context manager 342 to the location context manager 360. For example, if a location update 342 relates to a well-established location such as home or work, or relates to an unknown location, the location update 340 may not be transmitted to the location context manager 360. Similarly, if a location unique identifier confidence value corresponding to a location update 340 is too low, the location update 340 may not be transmitted to the location context manager 360. Additionally, the location context manager 342 can transmit the location updates 340 and visit updates 336 to the location context manager 360 after receiving a request for updates from the location context manager 360. The companion device 350 has limited resources relating to power, bandwidth, and processing power so it may be better if the location context manager 360 can determine (or receive an indication) that the companion device 350 has sufficient resources to receive and utilize the location updates 340 and the visit updates 336. The location context manager 360 can then transmit location updates 366 and visit updates 364 to a client application 362 on the companion device 350. Location updates 366 can include a location profile or related location information. Visit updates 364 can include a location profile or related location information.

In some examples, the client application 362 on the companion device 350 can include location-based widgets and notifications. The location updates 366 and visit updates 364 can enable the location-based widgets and notifications to surface more helpful information, suggestions, and other client application 362 functionality.

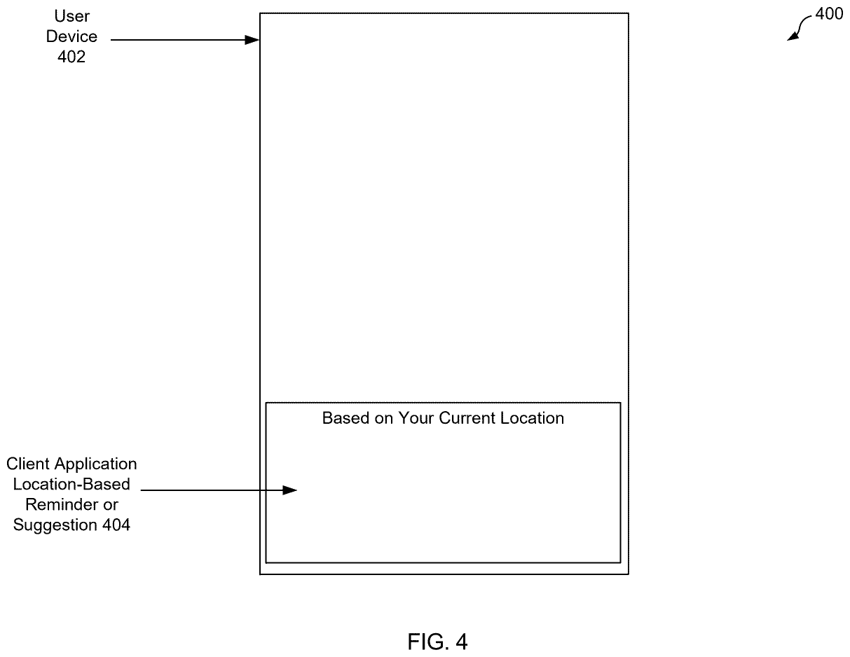

FIG. 4 illustrates an example diagram 400 related to techniques described herein. Example diagram 400 can illustrate an example user interface element related to location-based reminders and/or suggestions. The user device 402 can have a user interface. While the user device 402 is in operation, a reminder or suggestion 404 can be shown on the user interface of the user device 402. For example, the reminder or suggestion 404 can overlay the current activity, application, or screen of the user device 402 to indicate a location-based reminder or suggestion. In some examples, the reminder or suggestion 404 can be from a first-party application or operating system of the user device 402. In some examples, the reminder or suggestion 404 can be from a client application (for example, the client application 150 of FIG. 1) that received location profiles and associated information as described herein.

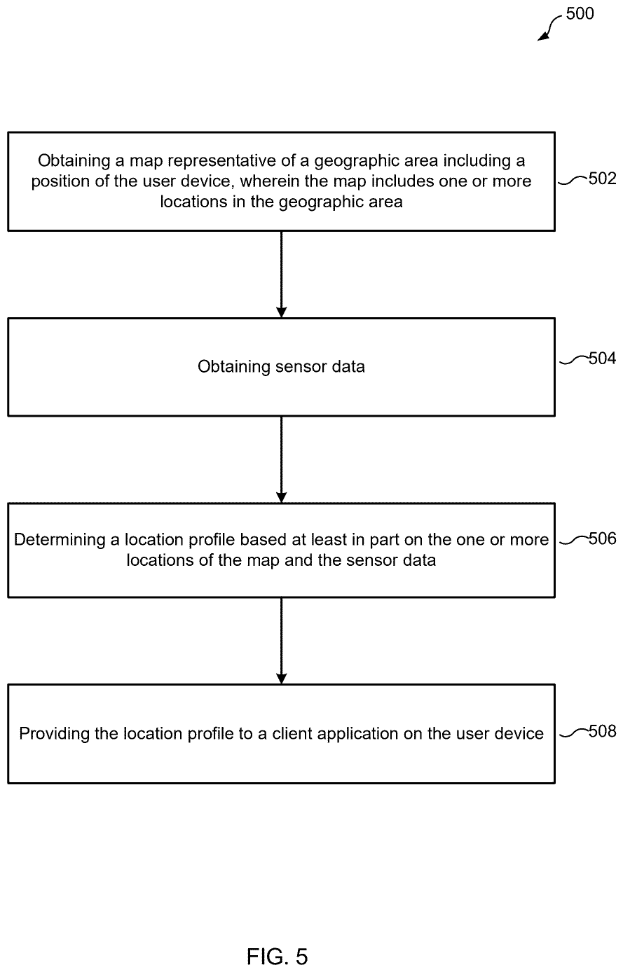

FIG. 5 illustrates an example process 500 associated with the techniques described herein. Example process 500 can be implemented on a user device (for example, user device 110 of FIG. 1). In some examples, a location service can include one or more of a geographic services manager 112, a map manager 120, a map cache 122, a location generator 130, a sensor data manager 132, a location profile manager 140, and a location profile cache 142 of FIG. 1. In some examples, a location service can include a location monitor 250 and a visited locations history 254 of FIG. 2. In some examples, a location service can include a visit manager 334 and a location context manager 342 of FIG. 3.

At block 502, a location service of a user device can obtain a map representative of a geographic area including the position of the user device. The map can include one or more locations in the geographic area. Obtaining the map can further include determining, by the location service, the position of the user device. Obtaining the map can further include transmitting, by the location service to a server, a map request including the position of the user device. Obtaining the map can further include receiving, by the location service from the server, the map. Obtaining the map can further include determining, by the location service, the position of the user device. Obtaining the map can further include determining, by the location service from a map cache on the user device, the map based at least in part on the position of the user device.

At block 504, the location service can obtain sensor data. In some examples, the sensor data can be a set of signal strengths received by an antenna of the user device at the position of the user device. The sensor data can be a set of wireless network signal strengths. The set of wireless network signal strengths can be a set of Wi-Fi signal strengths from Wi-Fi access points. In some examples, other parts of signals can be used for sensor data. For example, the service set identifier (SSID) of a signal can be used as sensor data. In some examples, transaction data on the user device or related to a profile on the user device that is related to the location can be used as sensor data. For example, if the location is a store, transaction data related to the store can be used. In some examples, the sensor data can include device motion data from an inertial measurement unit (IMU). For example, device motion data can indicate that the user holding or storing the user device is walking back and forth. In another example, the device motion data can indicate that the user holding or storing the user device is sitting. In another example, the device motion data can be used with geolocation trajectories. Device motion data can be used in conjunction with position data (for example, from GNSS) in order to generate an estimated position for the user device.

At block 506, the location service can determine a location profile based at least in part on the one or more locations of the map and sensor data. Determining the location profile can include determining a location identifier based at least in part on the one or more locations of the map and the sensor data. Determining the location profile can include transmitting, to a server, a location profile request including the location identifier. Determining the location profile can include receiving, from the server, the location profile. Determining the location profile can include determining, by the location service at a first time, a location identifier based at least in part on the one or more locations of the map and the sensor data. Determining the location profile can include determining by the location service from a location profile cache on the user device, the location profile based at least in part on the location identifier.

Determining the location profile can further include determining, by the location service, a location confidence score associated with the location profile based at least in part on the one or more locations of the map and the sensor data. The process 500 can further include providing, by the location service, the location confidence score to the client application.

At block 508, the location service can provide the location profile to a client application on the user device. The client application can be configured to transmit the location profile to a companion device of the user device. The companion device can be configured to present location-based information based at least in part on the location profile. The client application can be configured to transmit the location profile to the companion device based at least in part on a location confidence score associated with the location profile.

The process 500 can further include transmitting, by the location service to a server, a map request for one or more maps representative of one or more geographic areas adjacent to the geographic area including the position of the user device. The process 500 can further include receiving, by the location service from the server, the one or more maps.

The process 500 can further include determining, by the location service, one or more predicted positions of the user device within a time threshold. The process 500 can further include transmitting, by the location service to a server, a map request for one or more maps representative of one or more geographic areas including one or more predicted locations for the user device within the time threshold. The process 500 can further include receiving, by the location service from the server, the one or more maps.

The process 500 can further include determining, by the location service, one or more past locations of the user device within a time threshold, wherein the one or more locations are associated with one or more past positions of the user device. The process 500 can further include transmitting, by the location service to a server, a map request for one or more maps representative of one or more geographic areas including one or more past locations for the user device within the time threshold. The process 500 can further include receiving, by the location service from the server, the one or more maps.

The process 500 can further include storing the location profile in a location profile cache of the user device. The process 500 can further include tagging the location profile with a timestamp for when the location profile was determined, wherein the location profile represents a past location profile. The process 500 can further include receiving, by the location service from a second client application at a later time, a request for past location profiles within a past time period, wherein the past location profile is associated with a timestamp within the past time period. The process 500 can further include providing, by the location service to the second client application, the past location profile.

The process 500 can further include determining, by the client application, that the location profile is associated with workouts. The process 500 can further include causing, by the client application, the user device to present workout-related information based at least in part on the location profile. The workout-related information can be associated with a location type of the location profile.

The process 500 can further include obtaining the map and receiving the sensor data, which are performed during a first time period. The process 500 can further include, during a second time period, determining, by the location service, a second map representative of a second geographic area including a second position of the user device, wherein the second map includes second sensor data. The process 500 can further include during the second time period, receiving, by the location service, a second sensor data received at the second position of the user device. Determining the location profile can be further based at least in part on the second set of one or more locations of the second map and the second sensor data.

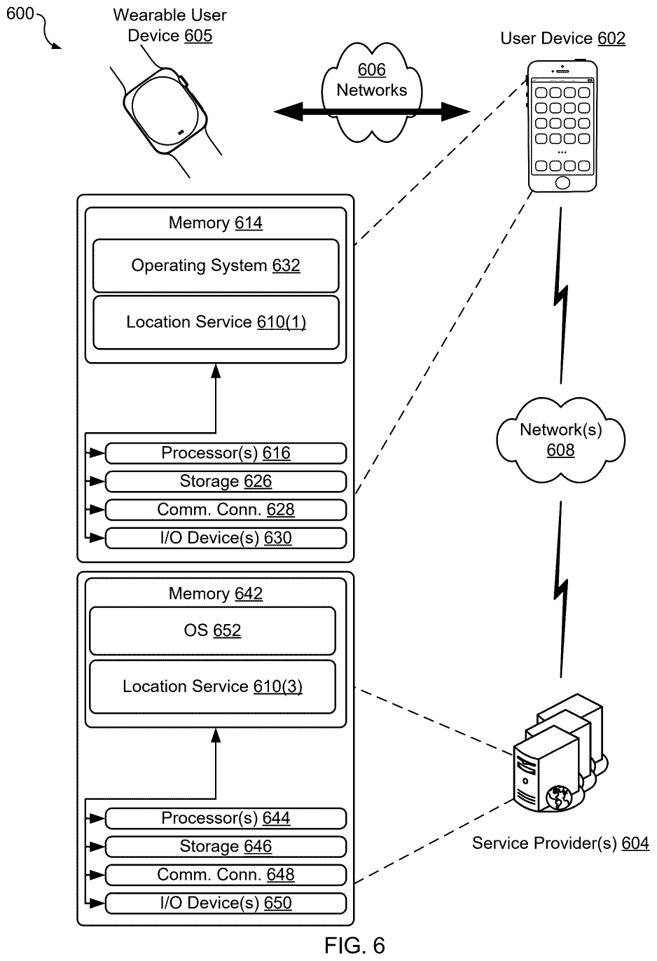

FIG. 6 illustrates an example architecture or environment 600 configured to implement techniques relating to providing and using detailed location profiles and associated information to client applications on a user device, according to at least one example. In some examples, the example architecture 600 may further be configured to enable a user device 602 (e.g., the user device 110 of FIG. 1), the service provider computers 604 (e.g., the servers hosting the map service 160 and the location service 162), and a wearable electronic device 605 (e.g., an example secondary device such as companion device 350) to share information. In some examples, the devices may be connected via one or more networks 608 and/or 606 (e.g., via Bluetooth, Wi-Fi, the Internet, or the like). In the architecture 600, one or more users may utilize the user device 602 to manage, control, or otherwise utilize the wearable electronic device 605, via the one or more networks 606. Additionally, in some examples, the wearable electronic device 605, the service provider computers 604, and the user device 602 may be configured or otherwise built as a single device. For example, the wearable electronic device 605 and/or the user device 602 may be configured to implement the examples described herein as a single computing unit, exercising the examples described above and below without the need for the other devices described.

In some examples, the networks 606, 608 may include any one or a combination of many different types of networks, such as cable networks, the Internet, wireless networks, cellular networks, satellite networks, other private and/or public networks, or any combination thereof. While the illustrated example represents the user device 602 accessing the service provider computers 604 via the networks 608, the described techniques may equally apply in instances where the user device 602 interacts with the service provider computers 604 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

As noted above, the user device 602 may be configured to collect and/or manage user activity data potentially received from the wearable electronic device 605. In some examples, the wearable electronic device 605 may be configured to provide health, fitness, activity, and/or medical data of the user to a third-or first-party application (e.g., the service provider computer 604). In turn, this data may be used by the user device 602 to identify trends and/or for sharing. The user device 602 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 602 may be in communication with the service provider computers 604 and/or the wearable electronic device 605 via the networks 608, 606, or via other network connections.

In one illustrative configuration, the user device 602 may include at least one memory 614 and one or more processing units (or processor(s)) 616. The processor(s) 616 may be implemented as appropriate in hardware, computer-executable instructions, firmware, or combinations thereof. Computer-executable instructions or firmware implementations of the processor(s) 616 may include computer-executable or machine-executable instructions written in any suitable programming language to perform the various functions described. The user device 602 may also include geo-location devices (e.g., a global positioning system (GPS) device or the like) for providing and/or recording geographic location information associated with the user device 602. In some examples, the wearable user device 605 may also include geo-location devices for providing and/or recording geographic location information associated with the wearable user device 605.

The memory 614 may store program instructions that are loadable and executable on the processor(s) 616, as well as data generated during the execution of these programs. Depending on the configuration and type of the user device 602, the memory 614 may be volatile (such as random-access memory (RAM)) and/or non-volatile (such as read-only memory (ROM), flash memory, etc.). The user device 602 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random-access memory (SRAM), dynamic random-access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 614 and the additional storage 626 are both examples of non-transitory computer storage media. Additional types of computer storage media that may be present in the user devices (i.e., 110, 310, 402, 602) may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 602. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 602 may also contain communications connection(s) 628 that allow the user device 602 to communicate with a data store, another computing device or server, user terminals, and/or other devices via the networks 608, 606. The user device 602 may also include I/O device(s) 630, such as a keyboard, a mouse, a pen, a voice input device, a touch input device, a display, an operating system 632 and/or one or more application programs or services for implementing the features disclosed herein including a location service 610(1). In some examples, the location service 610(1) may be configured to implement the features described herein. As described in detail with reference to later figures, the wearable user device 605 may include a memory that includes a similar location service, which may be accessible by one or more processors of the wearable user device 605. The service provider computer 604 may also include a memory 642 that includes a location service 610(3). In this manner, the techniques described herein may be implemented by any one, or a combination of more than one, of the computing devices (e.g., the wearable user device 605, the user device 602, or the service provider computer 604).

The service provider computers 604 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 604 may be in communication with the user device 602 and/or the wearable user device 605 via the networks 608, 606, or via other network connections.

In one illustrative configuration, the service provider computers 604 may include at least one memory 642 and one or more processing units (or processor(s)) 644. The processor(s) 644 may be implemented as appropriate in hardware, computer-executable instructions, firmware, or combinations thereof. Computer-executable instructions or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs. Depending on the configuration and type of service provider computer 604, the memory 642 may be volatile (such as RAM) and/or non-volatile (such as ROM, flash memory, etc.). The service provider computer 604 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein once unplugged from a host and/or power would be appropriate. The memory 642 and the additional storage 646, both removable and non-removable, are both additional examples of non-transitory computer-readable storage media.

The service provider computer 604 may also contain communications connection(s) 648 that allow the service provider computer 604 to communicate with a data store, another computing device or server, user terminals and/or other devices via the networks 608, 606. The service provider computer 604 may also include I/O device(s) 650, such as a keyboard, a mouse, a pen, a voice input device, a touch input device, a display, speakers, a printer, etc.

Turning to the contents of the memory 642 in more detail, the memory 642 may include an operating system 652 and/or one or more application programs or services for implementing the features disclosed herein including the location service 610(3).

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

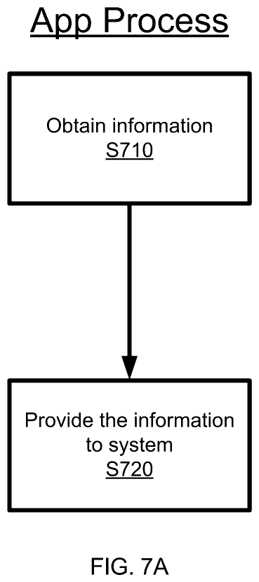

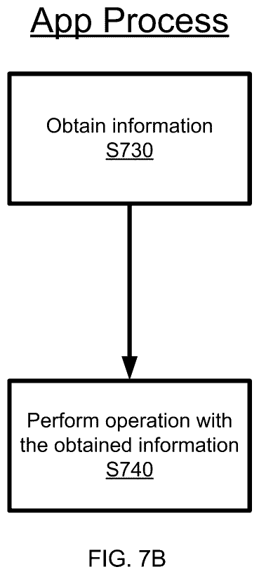

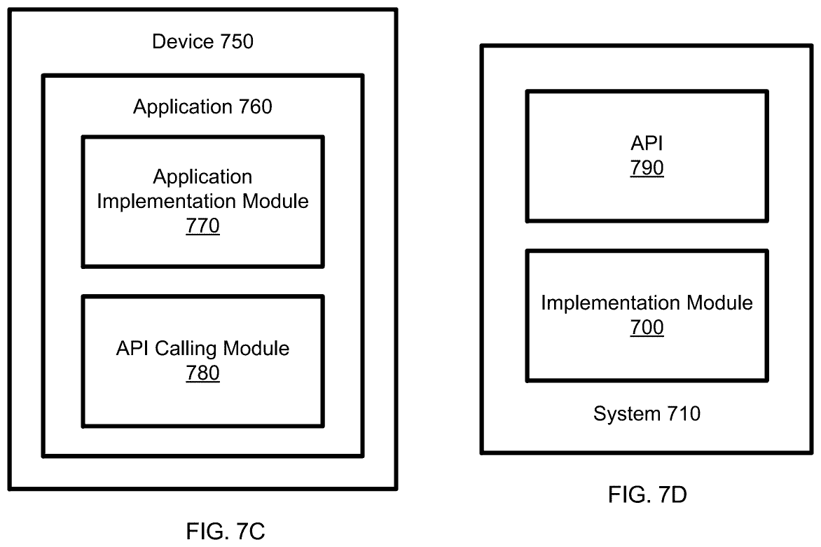

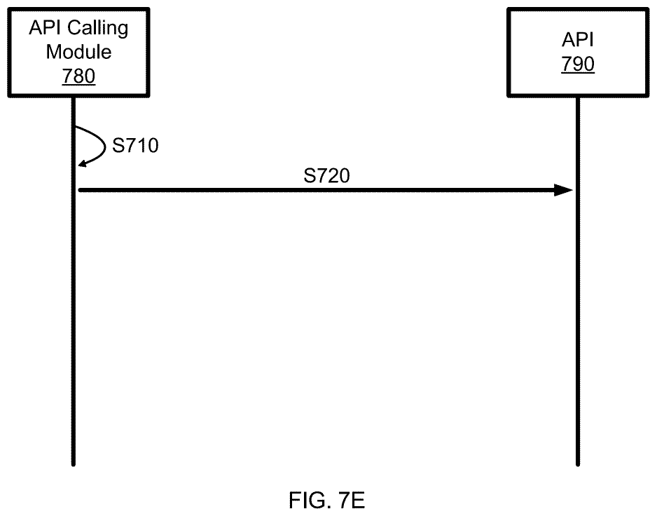

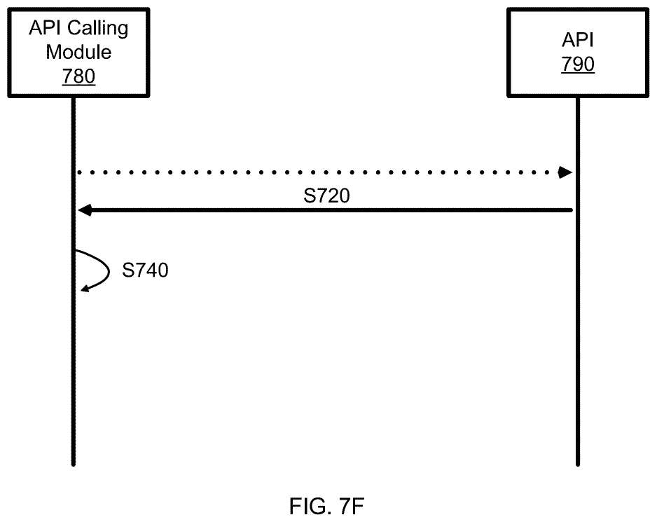

Implementations within the scope of the present disclosure include a computer-readable storage medium that encodes instructions organized as an application (e.g., application 760) that, when executed by one or more processing units, control an electronic device (e.g., device 750) to perform the method of FIG. 7A, the method of FIG. 7B, and/or one or more other processes and/or methods described herein.

It should be recognized that application 760 (shown in FIG. 7C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 760 is an application that is pre-installed on device 750 at purchase (e.g., a first party application). In other embodiments, application 760 is an application that is provided to device 750 via an operating system update file (e.g., a first party application or a second party application). In other embodiments, application 760 is an application that is provided via an application store. In some embodiments, the application store can be an application store that is pre-installed on device 750 at purchase (e.g., a first party application store). In other embodiments, the application store is a third-party application store (e.g., an application store that is provided by another application store, downloaded via a network, and/or read from a storage device).

Referring to FIG. 7A and FIG. 7E, application 760 obtains information (e.g., S710). In some embodiments, at S710, information is obtained from at least one hardware component of the device 750. In some embodiments, at S710, information is obtained from at least one software module of the device 750. In some embodiments, at S710, information is obtained from at least one hardware component external to the device 750 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 760 provides the information to a system (e.g., S720).

In some embodiments, the system (e.g., 710 shown in FIG. 7D) is an operating system hosted on the device 750. In some embodiments, the system (e.g., 710 shown in FIG. 7D) is an external device (e.g., a server, a peripheral device, an accessory, a personal computing device, etc.) that includes an operating system.

Referring to FIG. 7B and FIG. 7F, application 760 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 760 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 710 based on the information.

In some embodiments, one or more steps of the method of FIG. 7A and/or the method of FIG. 7B is performed in response to a trigger. In some embodiments, the trigger includes detection of an event, a notification received from system 710, a user input, and/or a response to a call to an API provided by system 710.

In some embodiments, the instructions of application 760, when executed, control device 750 to perform the method of FIG. 7A and/or the method of FIG. 7B by calling an application programming interface (API) (e.g., API 790) provided by system 710. In some embodiments, application 760 performs at least a portion of the method of FIG. 7A and/or the method of FIG. 7B without calling API 790.

In some embodiments, one or more steps of the method of FIG. 7A and/or the method of FIG. 7B includes calling an API (e.g., API 790) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 7C, device 750 is illustrated. In some embodiments, device 750 is a personal computing device, a smart phone, a smart watch, a fitness tracker, a head mounted display (HMD) device, a media device, a communal device, a speaker, a television, and/or a tablet. As illustrated in FIG. 7C, device 750 includes application 760 and an operating system (e.g., system 710 shown in FIG. 7D). Application 760 includes application implementation module 770 and API calling module 780. System 710 includes API 790 and implementation module 700. It should be recognized that device 750, application 760, and/or system 710 can include more, fewer, and/or different components than illustrated in FIGS. 7C and 7D.

In some embodiments, application implementation module 770 includes a set of one or more instructions corresponding to one or more operations performed by application 760. For example, when application 760 is a messaging application, application implementation module 770 can include operations to receive and send messages. In some embodiments, application implementation module 770 communicates with API calling module to communicate with system 710 via API 790 (shown in FIG. 7D).

In some embodiments, API 790 is a software module (e.g., a collection of computer-readable instructions) that provides an interface that allows a different module (e.g., API calling module 780) to access and/or use one or more functions, methods, procedures, data structures, classes, and/or other services provided by implementation module 700 of system 710. For example, API-calling module 780 can access a feature of implementation module 700 through one or more API calls or invocations (e.g., embodied by a function or a method call) exposed by API 790 and can pass data and/or control information using one or more parameters via the API calls or invocations. In some embodiments, API 790 allows application 760 to use a service provided by a Software Development Kit (SDK) library. In other embodiments, application 760 incorporates a call to a function or method provided by the SDK library and provided by API 790 or uses data types or objects defined in the SDK library and provided by API 790. In some embodiments, API-calling module 780 makes an API call via API 790 to access and use a feature of implementation module 700 that is specified by API 790. In such embodiments, implementation module 700 can return a value via API 790 to API-calling module 780 in response to the API call. The value can report to application 760 the capabilities or state of a hardware component of device 750, including those related to aspects such as input capabilities and state, output capabilities and state, processing capability, power state, storage capacity and state, and/or communications capability. In some embodiments, API 790 is implemented in part by firmware, microcode, or other low-level logic that executes in part on the hardware component.

In some embodiments, API 790 allows a developer of API-calling module 780 (which can be a third-party developer) to leverage a feature provided by implementation module 700. In such embodiments, there can be one or more API-calling modules (e.g., including API-calling module 780) that communicate with implementation module 700. In some embodiments, API 790 allows multiple API-calling modules written in different programming languages to communicate with implementation module 700 (e.g., API 790 can include features for translating calls and returns between implementation module 700 and API-calling module 780) while API 790 is implemented in terms of a specific programming language. In some embodiments, API-calling module 780 calls APIs from different providers such as a set of APIs from an OS provider, another set of APIs from a plug-in provider, and/or another set of APIs from another provider (e.g., the provider of a software library) or creator of the other set of APIs.

Examples of API 790 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi API, a Bluetooth API, an NFC API, a UWB API, a fitness API, a smart home API, contact transfer API, photos API, camera API, and/or image processing API. In some embodiments the sensor API is an API for accessing data associated with a sensor of device 750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 700 is a system (e.g., operating system, server system) software module (e.g., a collection of computer-readable instructions) that is constructed to perform an operation in response to receiving an API call via API 790. In some embodiments, implementation module 700 is constructed to provide an API response (via API 790) as a result of processing an API call. By way of example, implementation module 700 and API-calling module 780 can each be any one of an operating system, a library, a device driver, an API, an application program, or other module. It should be understood that implementation module 700 and API-calling module 780 can be the same or different types of modules from each other. In some embodiments, implementation module 700 is embodied at least in part in firmware, microcode, or other hardware logic.

In some embodiments, implementation module 700 returns a value through API 790 in response to an API call from API-calling module 780. While API 790 defines the syntax and result of an API call (e.g., how to invoke the API call and what the API call does), API 790 might not reveal how implementation module 700 accomplishes the function specified by the API call. Various API calls are transferred via the one or more application programming interfaces between API-calling module 780 and implementation module 700. Transferring the API calls can include issuing, initiating, invoking, calling, receiving, returning, and/or responding to the function calls or messages. In other words, transferring can describe actions by either of API-calling module 780 or the implementation module 700. In some embodiments, a function call or other invocation of API 790 sends and/or receives one or more parameters through a parameter list or other structure.

In some embodiments, implementation module 700 provides more than one API, each providing a different view of or with different aspects of functionality implemented by implementation module 700. For example, one API of implementation module 700 can provide a first set of functions and can be exposed to third party developers, and another API of implementation module 700 can be hidden (e.g., not exposed) and provide a subset of the first set of functions and also provide another set of functions, such as testing or debugging functions which are not in the first set of functions. In some embodiments, implementation module 700 calls one or more other components via an underlying API and thus is both an API calling module and an implementation module. It should be recognized that implementation module 700 can include additional functions, methods, classes, data structures, and/or other features that are not specified through API 790 and are not available to API calling module 780. It should also be recognized that API calling module 780 can be on the same system as implementation module 700 or can be located remotely and access implementation module 700 using API 790 over a network. In some embodiments, implementation module 700, API 790, and/or API-calling module 780 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 500 (FIG. 5) is performed at a first computer system (as described herein) via a system process (e.g., an operating system process, a server system process) that is different from one or more applications executing and/or installed on the first computer system.

In some embodiments, process 500 (FIG. 5) is performed at a first computer system (as described herein) by an application that is different from a system process. In some embodiments, the instructions of the application, when executed, control the first computer system to perform process 500 (FIG. 5) by calling an application programming interface (API) provided by the system process. In some embodiments, the application performs at least a portion of process 500 (FIG. 5) without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 500 (FIG. 5) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 790 defines a first API call that can be provided by the API calling module 780. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 750) that runs the application. In some embodiments, the implementation module is included in an electronic device that is separate from the device that runs the application.

The various examples can be further implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems, and other devices capable of communicating via a network.

Most examples utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C#or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, controls an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating the importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in a different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include the use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve the performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of the increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secure datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems have been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A computer-implemented method, comprising:
obtaining, by a location service implemented on a user device, a map representative of a geographic area corresponding to a position of the user device, wherein the map includes one or more locations in the geographic area;
obtaining, by the location service, sensor data of the user device;
determining, by the location service, a location identifier based at least in part on the one or more locations of the map and the sensor data;
generating, by the location service, a location profile associated with the location identifier, the location profile comprising one or more characteristics of the one or more locations in the geographic area; and
providing, by the location service, the location profile to a client application on the user device.

2. The computer-implemented method of claim 1, wherein the sensor data comprises wireless signal strength data, and determining the location identifier comprises generating a wireless signal fingerprint based on a service set identifier (SSID) and the wireless signal strength data.

3. The computer-implemented method of claim 1, further comprising:
transmitting, by the location service to a server, a map request for one or more maps representative of one or more geographic areas adjacent to the geographic area including the position of the user device; and
receiving, by the location service from the server, the one or more maps.

4. The computer-implemented method of claim 1, further comprising:
determining, by the location service, one or more predicted positions of the user device within a time threshold;
transmitting, by the location service to a server, a map request for one or more maps representative of one or more geographic areas including one or more predicted locations for the user device within the time threshold; and
receiving, by the location service from the server, the one or more maps.

5. The computer-implemented method of claim 1, further comprising:
determining, by the location service, one or more past locations of the user device within a time threshold, wherein the one or more locations are associated with one or more past positions of the user device;
transmitting, by the location service to a server, a map request for one or more maps representative of one or more geographic areas including one or more past locations for the user device within the time threshold; and
receiving, by the location service from the server, the one or more maps.

6. The computer-implemented method of claim 1, wherein generating, by the location service, the location profile includes:
determining, by the location service at a first time, a location identifier based at least in part on the one or more locations of the map and the sensor data; and
determining, by the location service from a location profile cache on the user device, the location profile based at least in part on the location identifier.

7. The computer-implemented method of claim 1, further comprising storing the location profile in a location profile cache of the user device.

8. The computer-implemented method of claim 7, further comprising:
tagging the location profile with a timestamp for when the location profile was determined, wherein the location profile represents a past location profile;
receiving, by the location service from a second client application at a later time, a request for past location profiles within a past time period, wherein the past location profile is associated with a timestamp within the past time period; and
providing, by the location service to the second client application, the past location profile.

9. A system, comprising:
one or more processors; and
a computer-readable medium comprising instructions that, when executed by the one or more processors, cause the system to:
obtain, by a location service implemented on a user device, a map representative of a geographic area corresponding to a position of the user device, wherein the map includes one or more locations in the geographic area;
obtain, by the location service, sensor data of the user device;
determine, by the location service, a location identifier based at least in part on the one or more locations of the map and the sensor data;
generate, by the location service, a location profile associated with the location identifier, the location profile comprising one or more characteristics of the one or more locations in the geographic area; and
provide, by the location service, the location profile to a client application on the user device.

10. The system of claim 9, wherein obtaining the map further includes:
determining, by the location service, the position of the user device;
transmitting, by the location service to a server, a map request including the position of the user device; and
receiving, by the location service from the server, the map.

11. The system of claim 9, wherein determining the map further includes:
determining, by the location service, the position of the user device; and
determining, by the location service from a map cache on the user device, the map based at least in part on the position of the user device.

12. The system of claim 9, wherein generating the location profile includes:
determining, by the location service, a location confidence score associated with the location profile based at least in part on the one or more locations of the map and the sensor data; and
providing, by the location service, the location confidence score to the client application.

13. The system of claim 9, wherein the sensor data includes a set of wireless network signal strengths.

14. The system of claim 13, wherein the set of wireless network signal strengths includes a set of Wi-Fi signal strengths from Wi-Fi access points.

15. The system of claim 9, the instructions further causing the system to:
determine, by the client application, that the location profile is associated with workouts; and
cause, by the client application, the user device to present workout-related information based at least in part on the location profile.

16. A non-transitory computer-readable medium storing computer-executable instructions that, when executed by one or more processors, cause the one or more processors to perform operations comprising:
obtaining, by a location service implemented on a user device, a map representative of a geographic area corresponding to a position of the user device, wherein the map includes one or more locations in the geographic area;
obtaining, by the location service, sensor data of the user device;
determining, by the location service, a location identifier based at least in part on the one or more locations of the map and the sensor data;
generating, by the location service, a location profile associated with the location identifier, the location profile comprising one or more characteristics of the one or more locations in the geographic area; and
providing, by the location service, the location profile to a client application on the user device.

17. The non-transitory computer-readable medium of claim 16, wherein obtaining the map and receiving the sensor data are performed during a first timer period, and wherein the operations further comprise:
during a second time period:
determining, by the location service, a second map representative of a second geographic area including a second position of the user device, wherein the second map includes a second set of one or more locations;
receiving, by the location service, second sensor data, and
wherein generating the location profile is further based at least in part on the second set of one or more locations of the second map and the second sensor data.

18. The non-transitory computer-readable medium of claim 16,
wherein the client application is configured to transmit the location profile to a companion device of the user device.

19. The non-transitory computer-readable medium of claim 18, wherein the companion device is configured to present location-based information based at least in part on the location profile.

20. The non-transitory computer-readable medium of claim 18, wherein the client application is configured to transmit the location profile to the companion device based at least in part on a location confidence score associated with the location profile.
